(19) United States
(12) Patent Application Publication
(10) Pub. No.: US 2026/0292296 A1
(43) Pub. Date: Sep. 24, 2026

(54) FAMILIARITY WITH MEDIA CONTENT VIA MIMICKING

(71) Applicant: Adeia Guides Inc., San Jose, CA (US)

(72) Inventors: Zhiyun Li, Kenmore, WA (US); Ning Xu, Irvine, CA (US); Jean-Yves Couleaud, Mission Viejo, CA (US)

(21) Appl. No.: 19/087,202

(22) Filed: Mar. 21, 2025

(51) Int. Cl. H04N 21/439; G06Q 30/0251; G10L 15/02; H04N 21/81

(52) U.S. Cl. CPC H04N 21/4394; G06Q 30/0251; G10L 15/02; H04N 21/812; G10L 2015/025

(57) ABSTRACT

The present application provides for detection of user mimicry of presented media content. An example method includes presenting, by an output device, media content comprising media content audio, and receiving, during presentation of the media content by the output device, input audio. The method includes aligning the input audio with the media content audio, determining a similarity score based on the aligned input audio and media content audio, and based on determining that the similarity score is above a similarity threshold, taking an appropriate action such as modifying presentation of the media content.

### BACKGROUND

This disclosure is related to systems and methods for detecting mimicry of media content during playback of the media content (e.g., during presentation of an advertisement), and in particular to systems and methods for tracking user mimicry and taking appropriate actions in response.

### SUMMARY

Advertisement-supported videos on television or other user devices have become increasingly common, such as Hulu, Tubi, and Pluto TV. These platforms often repeatedly display the same advertisements to audiences in hopes of leaving a lasting impression. However, it is currently difficult or impossible to accurately gauge viewers' familiarity with particular advertisements, meaning that advertisers and media content providers are left with limited information about the impact and/or effectiveness of the displayed advertisements. Within the framework of repeated advertisement display, some viewers may become frustrated by viewing the same advertisement repeatedly if they are already familiar with the advertisement. Additionally, it may be inefficient and/or costly for advertisers to continue to repeatedly display the same advertisement to a user that is already familiar with the advertisement. The benefit of repeated presentation of the advertisement may be diminished for user's that are already familiar with the advertised product or brand. Additionally, return on investment for repeated presentation of the same advertisement may not be justified for some users, particularly for users that may be turned off from the advertised product after repeated viewings. Furthermore, the lack of granular information about particular users' familiarity with presented advertisements prevents advertisers from optimizing which ads are presented to which users, as well as preventing the modification of advertisements across repeated presentations to align with a given user's interests and/or familiarity. In some cases, this can lead to less efficient use of computing resources to store and present advertisements that are not effective.

In one approach, a media content provider may simply count the number of times that a given advertisement has been presented to a user and use that number as an indication of the user's familiarity with the advertisement. However, this approach simply provides a number of times the advertisement has been presented and does not indicate whether the user actually saw the advertisement, whether the user remembers the advertisement, whether the user interacted with the advertisement in any way (e.g., singing along, copying iconic gestures or sounds from the advertisement, etc.), or any other nuanced metric regarding the impact of the advertisement on the user.

In another approach, a media content provider may present an interactive advertisement or a voice-activated advertisement. For interactive advertisements, the user may be invited to interact by making a selection or navigating through one or more options. The interactive advertisement may require a user to perform a task or make a decision that impacts the content that is presented or wait for a timer to progress before the advertisement can continue. Example interactive advertisements may include (1) quizzes and polls, wherein advertisements may integrate short quizzes or polls within the presented video to encourage viewers to interact, and the user responses may then guide the narrative of the advertisement or may result in personalized recommendations; (2) choose-your-own-adventure, wherein an advertisement allows a user to make decisions at key points, leading to potentially different outcomes or paths; (3) clickable hotspots, wherein an advertisement includes an interactive area within the video that a user may click on or select to learn more about a product, watch additional content, or make a purchase; (4) surveys and feedback forms, wherein at the end of a video the user may be prompted to complete a survey or provide feedback; (5) product demos and tutorials, wherein the presented video is an interactive video that allows the user to try out features, customize products, or explore services in a virtual environment; and (6) call-to-action (CTA) overlays, wherein clear, actionable steps are incorporated into the video, such as “Click here to learn more” or “Shop now,” which may guide the user through a desired action path.

For voice-activated advertisements, a presented advertisement may be designed to engage users by encouraging them to speak aloud. These systems may use voice recognition technology to enhance user engagement. For example, platforms like Google, Amazon, and other tech companies have developed voice-activated ads, especially on smart devices like Google Home or Amazon Alexa. These ads encourage users to respond verbally to prompts, such as asking a question or saying a specific phrase to learn more or access a special offer.

The interactive and voice-activated advertisements described above, however, require user participation to progress, or require a timer to elapse without user input before the advertisement can progress. These advertisements aim to further engage the user with particular content by explicitly requesting the user to perform certain actions. Therefore, the advertisement content must be specifically designed to wait for those actions to be performed in order to progress with the advertisement. Without the user's action, the advertisement will not proceed seamlessly and completely. In addition, some display devices (e.g., a television screen) may make it difficult to perform the requested actions due to limited user interfaces or functionality.

With these issues in mind, embodiments of the present disclosure attempt to obtain more insight into user familiarity with advertisements, including more granular information about whether a user is singing along or repeating certain phrases or gestures, for example, and to provide appropriate rewards to users and advertisers when the user successfully mimics some portions of an advertisement. Additionally, embodiments of this disclosure aim to capture user input either actively in response to a prompt or passively as an advertisement progresses. This may enable the advertisement to play through without interruption, and without requiring user interaction to continue. Further, embodiments of this disclosure aim to enable media content providers and/or advertisers to remain focused on making advertisements that are catchy, funny and memorable, and do not disrupt the user's viewing experience.

To help address the issues noted above, systems and methods are provided herein for measuring user engagement with video advertisements by detecting when users mimic phrases or actions from the advertisement, rather than relying on traditional interactive methods. The systems and methods disclosed herein may enable seamless advertisement playback while passively tracking user familiarity, and providing real-time feedback and rewards based on natural user behaviors. Advanced audio and content analysis techniques may ensure that user mimicry is accurately measured, thereby increasing the likelihood that advertisement selection for a given user is optimized.

In an embodiment, a method includes presenting, by an output device, media content comprising media content audio. The media content may comprise an advertisement, and the media content audio may comprise advertisement audio. The method also includes receiving, during presentation of the media content by the output device, input audio. The input audio may comprise words spoken by a user viewing the media content. The method then includes aligning the input audio (e.g., user audio) with the media content audio (e.g., advertisement audio). The user may mimic or repeat certain words or phrases on a delay with respect to the presented media content, requiring the system to align the two signals for more accurate analysis. The method may then include determining a similarity score based on the aligned input audio and media content audio, and then based on determining that the similarity score is above a similarity threshold, modifying presentation of the media content. In some examples, modifying the presentation of the media content may include skipping to the end of the media content (e.g., ending the advertisement), and/or taking any other suitable action such as those described herein.

In some embodiments, aligning the input audio with the media content audio comprises performing a weighted alignment between the input audio and the media content audio based on both (1) respective audio features of the input audio and the media content audio, and (2) respective content features of the input audio and the media content audio. The audio features may comprise one or more of mel frequency cepstrum coefficients (MFCC), spectrograms, or spectral characteristics of the input audio and the media content audio. The content features may comprise one or more of word embeddings, phonemes, or textual representations of the input audio and the media content audio.

In some embodiments, performing the weighted alignment between the input audio and the media content audio comprises using dynamic time warping (DTW) and a hybrid cost function that combines contributions from the audio features of both the input audio and the media content audio, and the content features of both the input audio and the media content audio.

In some embodiments, determining the similarity score comprises analyzing the input audio and the media content audio based on one or more of phoneme matching, pitch matching, timing precision, or lead time. Any other suitable analysis may be performed as well or instead, in order to determine how similar the user's input is to the audio from the presented media content.

In some embodiments, the method may also include providing a visual indication overlaid on the presentation of the media content that the similarity score is above the similarity threshold. That is, the output device may present an icon indicating that the user has successfully mimicked the currently presented advertisement. Other indications may be used as well or instead, such as an audio alert or chime, which may indicate that the similarity between the user input (e.g., audio, gestures, etc.) and the media content is above a threshold similarity.

In some embodiments, based on determining that the similarity score is above the similarity threshold, the method may include either automatically skipping presentation of a portion of the media content, or providing a user selectable option to skip presentation of a portion of the media content (e.g., ending the advertisement early, skipping to a next advertisement, etc.). Additionally, or alternatively, the method may include providing a reward to the user, wherein the reward is selected based on the similarity score.

In some embodiments, the method may include selecting the media content (e.g., advertisement) based on an ad-targeting algorithm, and modifying the ad-targeting algorithm based on that the similarity score is above the similarity threshold. That is, when a user successfully mimics a given advertisement, that may act as feedback to the ad-targeting algorithm in order to further optimize the algorithm itself.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative scenario in which a user mimics a phrase from a presented advertisement, in accordance with some embodiments of this disclosure.

FIG. 2 shows two illustrative scenarios in which an output device indicates to a user that the user should attempt to mimic a displayed advertisement, in accordance with some embodiments of this disclosure.

FIG. 3 shows an illustrative scenario in which the output device provides an indication of a successful mimic by the user, in accordance with some embodiments of this disclosure.

FIG. 4 shows four charts illustrating how media content audio and user input audio can be aligned and compared, in accordance with some embodiments of this disclosure.

FIG. 5 shows illustrative user equipment devices, in accordance with some embodiments of this disclosure.

FIG. 6 shows illustrative systems, in accordance with some embodiments of this disclosure.

FIG. 7 is a flowchart of a detailed illustrative process for determining whether a user is mimicking a displayed media content, in accordance with some embodiments of this disclosure.

### DETAILED DESCRIPTION

As noted above, embodiments of the present disclosure relate to capturing user mimicry of advertisements or other media content presented by a device such as a television, tablet, or other display device. Embodiments disclosed herein may enable systems to measure viewer engagement with presented media content (e.g., advertisements, movies, TV shows, news, animations, still images, audio, and/or a combination thereof), which can then be used to provide rewards to the user and/or advertising system to better optimize the presentation of advertisements or other media content to users. Among other benefits, embodiments disclosed herein may enable mimicry-based familiarity detection, in which the system passively detects when a viewer mimics phrases or gestures from displayed media content (e.g., advertisements), thereby providing an implicit measure of viewer familiarity, unlike conventional interactive ads that require explicit viewer input. Embodiments disclosed herein may also enable a seamless advertising experience in which advertisements can be presented without interruption whether or not the viewer interacts, thereby allowing continuous viewing while still offering rewards (like shortened ads) based on detected familiarity. Embodiments disclosed herein may also enable advanced mimicry analysis, in which the system uses a weighted alignment technique that evaluates viewer mimicry based on phonemes, pitch, and timing, among other things, offering a more detailed engagement measurement compared to other voice recognition systems. Embodiments disclosed herein may also enable natural engagement between a user and a presented media content, wherein the system engages with common user behaviors, especially among younger audiences who naturally mimic catchy ad content, making engagement more intuitive. Some embodiments also enable gamification of the media content viewing experience, wherein a reward is provided when a user mimics media content ahead of time, so that the ad voice sounds like a follower instead. Embodiments disclosed herein may also enable improved media content recommendation (e.g., for advertisements), for example by detecting the age and/or gender of the viewer who mimics the voice, allowing the media content platform to have more information to adjust their media content selection for each user. Embodiments disclosed herein may also enable real-time adaptation, wherein the system offers real-time rewards or changes to media content based on the level of viewer familiarity (e.g., changing the media content presented based on how familiar the user is with the currently displayed media content), thereby enabling improved media content recommendations and lower computational costs.

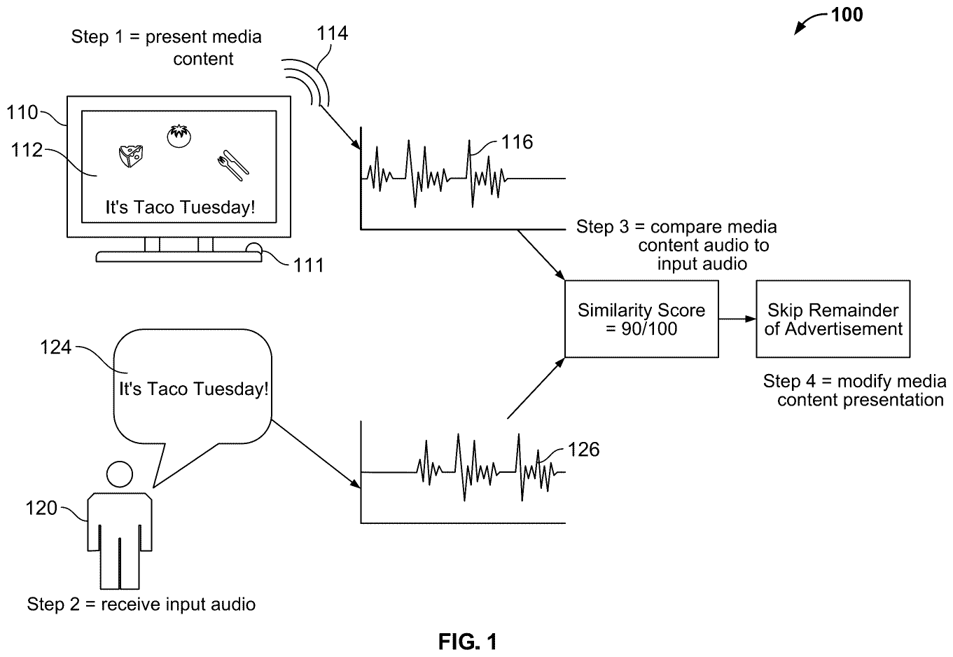

FIG. 1 illustrates an example scenario 100 in which a user mimics a phrase from a presented advertisement. For the purpose of the example shown in FIG. 1, the advertisement may be a short video. However, it should be appreciated that the presented media content may be a video, animation, still image(s), audio, or any combination thereof. Scenario 100 illustrates an output device 110, which may be a television, computer, tablet, phone, virtual reality device, augmented reality device, extended reality device, or any other suitable device for presenting media content. In the illustrated example, the output device 110 includes one or more sensors 111, which may be configured to capture and/or receive input audio, video, gestures, movements, sounds, etc. from one or more users in the vicinity of the output device 110. In some examples, the sensor 111 may be connected to or physically a part of the output device 111. In other examples, the sensor 111 may be part of a separate device, and may be communicatively coupled to the output device 110. For example, the sensor 111 may be a part of a remote control for the output device 110, or a smartphone or other device having a microphone, camera, inertial sensor, or other suitable sensor for capturing audio, video, gestures, etc.

The output device 110 may be configured to display media content 112 (e.g., advertisements, movies, TV shows, news, etc.). The media content 112 may have corresponding media content audio 114 (e.g., “It's Taco Tuesday”) which a user may attempt to mimic. The media content 112 may also have a corresponding gesture and/or visual component, such as recognizable arm or hand movements, dance moves, etc.

Scenario 100 also illustrates a user 120 in the vicinity of the output device 110. The user 120 may have a corresponding user profile, and/or may be logged in to the output device 110. In some examples, there may be multiple users present, multiple users logged in to the output device, a family of users (e.g., kid(s) and parent(s)), etc. As shown in FIG. 1, the user may speak aloud during presentation of the media content 112 to mimic some portion of the media content 112. In the illustrated embodiment, the user speaks “It's Taco Tuesday” (audio 124) to mimic the media content audio 114 output by the output device 110.

Scenario 100 illustrates an example process of detecting user mimicry and taking an appropriate action, according to embodiments of the present disclosure. At step 1, the output device 110 presents media content 112 (e.g., an advertisement) including media content audio 114. At step 2, the user 120 viewing the media content 112 speaks audio 124 in an attempt to mimics the media content audio 114. In some embodiments, the output device 110 may passively capture input audio, video, gestures, motions, sounds, etc., via sensor 111. Sensor 111 may be a part of or connected to the output device itself, or may be a separate device (e.g., remote control, phone, tablet, dedicated microphone, etc.).

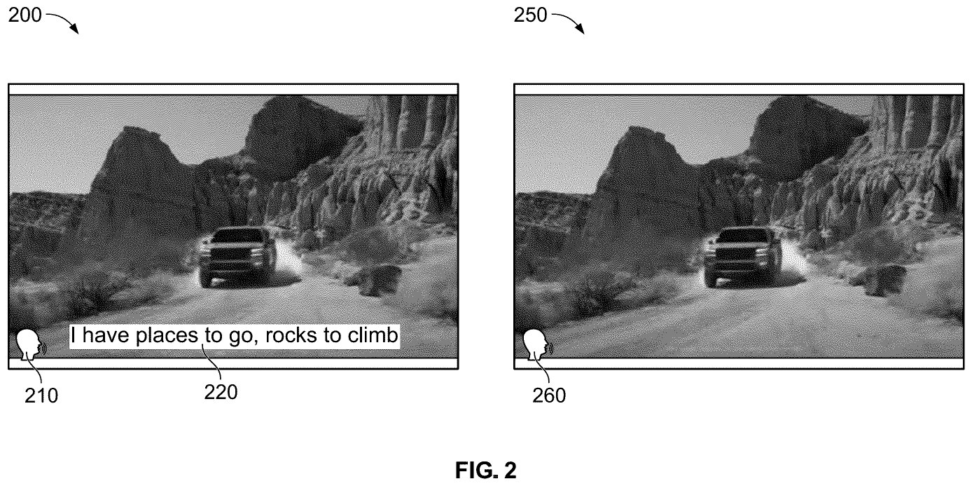

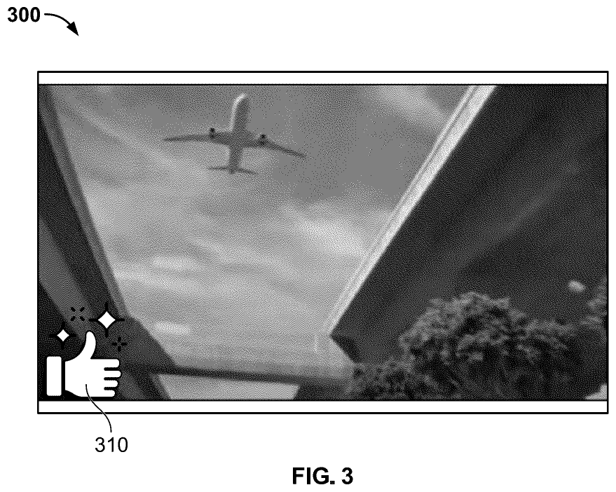

In some examples, the output device 110 (or a connected device such as a remote control or phone) may prompt the user 120 to provide corresponding input audio 124. This is described in further detail below with respect to FIGS. 2-3.

In some examples, the system may analyze input audio 124 to identify the age, demographic, or other characteristic of the user 120. This information may then be used to provide a user-appropriate reward, improve media content recommendations, and/or provide more targeted or relevant media content to the user.

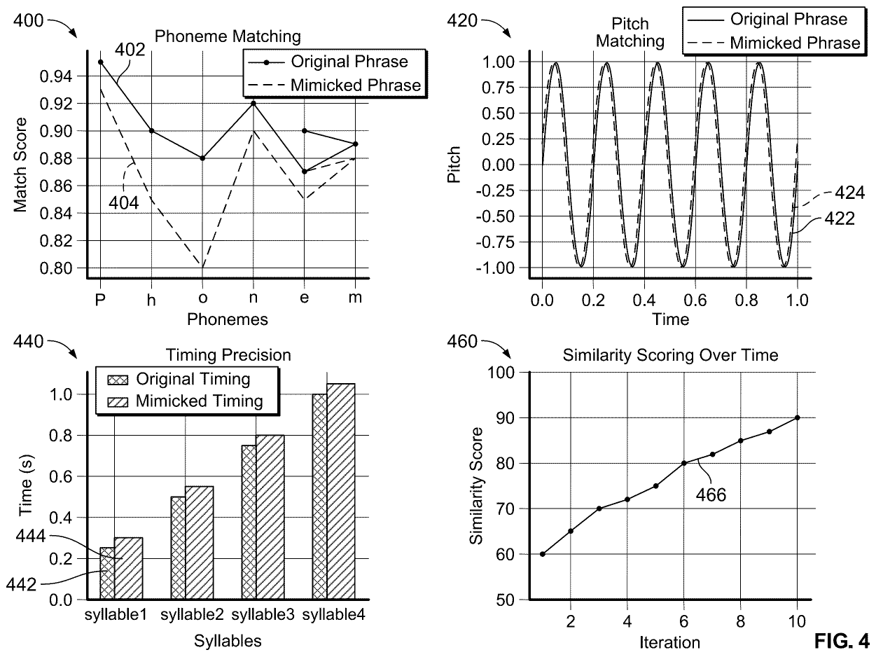

At step 3, the system compares the media content audio 114 to the user audio or input audio 124. FIG. 1 illustrates a first audio signal 116 representing the media content audio 114, and a second audio signal 126 representing the input audio 124 from the user 120. The system performs a similarity analysis by first aligning and then comparing the two signals. The comparison between the media content audio signal and the user input audio signal is described in further detail below with respect to FIG. 4. In brief, the comparison between the audio signals may include aligning the audio signals via a weighted alignment, and then performing a comparison of the signals based on both the audio features (e.g., spectral components of the audio signals) and the content features (e.g., the words/phrases etc. that make up the audio signals).

In some examples, the system may compare the media content signal and user input signal to determine a similarity score. The similarity score may reflect how close the user input 124 was to mimicking the media content audio 114, for example with a score of zero (0) corresponding to no similarity and a score of 100 corresponding to the two audio signals being identical in both audio features and content features. In some embodiments, the system may use other scales and/or metrics to determine the similarity between the two signals. For example, instead of or in addition to a similarity score ranging from 1-100, the system may use a similarity number, value, letter grade, percentage, binary yes/no, color-based metric (e.g., red, yellow, green), or any other suitable metric. In addition, the scale used to determine whether a given similarity score is above the similarity threshold may range from 0-1, 0-100, along a color spectrum, a letter grade spectrum, and/or any other suitable scale or spectrum.

In the scenario 100 of FIG. 1, at step 3 the system has determined that the similarity score between the media content audio 114 and the user input audio 124 is a score of 90/100. The system may include a predetermined similarity threshold. If the similarity score is equal to or above the similarity threshold, that may indicate that the user has successfully mimicked the presented media content.

Then, at step 4, based at least in part on determining that the similarity score is above the similarity score threshold, the system may take one or more appropriate responsive actions. As shown in FIG. 1, one possible action is for the system to skip presentation of the remainder of the media content (either automatically, or after presenting a user selectable option). For example, where the media content 112 is an advertisement and the user successfully mimics a portion of the advertisement during its presentation, the resulting action may be that the system ends the presentation of the advertisement. Other actions that may be performed based on the similarity score being above the similarity score threshold may include presenting an acknowledgment of the mimicry (e.g., visual, sound, thumbs up, etc.); presenting a user selectable option to skip forward in the presented media content; automatically skipping forward in the presented media content without additional user input (e.g., skipping a portion of the displayed media content); providing a reward to the user (e.g., points, scores, levels, etc.); changing an algorithm, weight, or other analysis technique used to determine and/or recommend subsequent media content to be presented to the user at a later time (e.g., changing/rearranging a queue of advertisement that will be displayed to the user based on whether the user mimics one or more of the advertisements), and more.

Whether the system detects mimicry or not (e.g., whether the determined similarity score is above or below the similarity score threshold), the system may continue to present the media content as normal. That is, the system may not wait for or require any user input and may instead proceed normally as if no user interaction is expected at all.

FIG. 2 illustrates a two-step process for engagement with the system disclosed herein. Over time, the system may develop and improve as the user becomes more familiar with particular content. One purpose of the two-step process may be to enable the user to discover the mimicry feature without interrupting the ordinary viewing experience. For example, the system may make use of a familiar Karaoke-like user interface (e.g., providing the words to be mimicked as captions).

The system may prompt the user to provide input (e.g., audio, gestures, etc.). For example, the output device may prompt the viewer to mimic a specific phrase that is central to the presented advertisement. The viewer may or may not participate by repeating the highlighted phrases. If the viewer does not participate by repeating the highlighted phrase, the advertisement may proceed as usual. Otherwise, the system may engage the viewer in two stages.

In the first stage, shown in scenario 200, the system operates a learning stage. This may enable users to find the mimicry functionality and become familiar with how it operates. As shown in scenario 200, to initialize the engagement, a speaker icon 210 may be displayed by the output device (e.g., device 110) to prompt the viewer to mimic the media content audio 220 “I have places to go, rocks to climb.” The system may automatically display or turn on subtitles 220 to display the corresponding phrase that should be mimicked. The system may also activate a sensor (e.g., sensor 111), which may be a microphone, camera, or other suitable sensor for capturing user speech, gestures, or other input. In some examples, the system may activate a microphone within a remote control, phone, or digital assistant communicatively connected to the output device to enter a listening mode in anticipation of the user providing user input. In some examples, the system may present the icon 210 and/or subtitles 220 at a time during the presentation of the media content that corresponds to when the user should begin mimicking the media content. For example, when the tagline of the advertised product/service is being presented, the output device may indicate via icon 210 that the user should provide an input mimicking the media content. The icon 210 may simply indicate that input should be provided, or may provide additional information as well, such as whether the user should provide audible input, visual input, gestures, sing along with the media content, and/or other information that the user may use to determine how exactly they should provide the user input mimicking the media content. In some examples, the icon 210 may begin being displayed when a time window for user mimicry opens and may be removed from being displayed when the time window for user mimicry ends, such that the user may provide user input mimicking the media content only during the time window for which the icon 210 is displayed.

As the user becomes more familiar with the process of mimicking media content, the system may proceed to a second stage or practicing stage. As shown in FIG. 2, the scenario 250 Illustrates that as the user becomes more familiar (e.g., through repeated use of the system), the system may hide the subtitles and expect the viewer to mimic the phrase as close as possible to the voice in the presented advertisement. The speaker icon 260 may be displayed within the given time window for which the user's mimicry is expected. Various other information may or may not be displayed, such as the information indicating how the user should provide input (e.g., audio, visual, gestures, etc.).

FIG. 3 illustrates a scenario 300 showing how the icon 310 may change to visually indicate that the user has successfully mimicked the displayed media content (e.g., that the similarity score between the media content and the user input is above the predetermined similarity score threshold). Scenario 300 shows that based at least in part upon detecting a successful mimicry from the user (e.g., based on the determined similarity score), the system may acknowledge the viewer's familiarity by displaying an icon 310. For example, the icon 310 may comprise a thumbs-up icon, or any other suitable visual indicator. In some embodiments, the system may also or alternatively provide an audible alert or other output to indicate successful mimicry. In addition, the system may offer a reward, such as shortening the displayed media content (e.g., advertising) as a result of a successful mimicry. In some examples, the system may provide other information upon detection of successful mimicry, such as a counter indicating the number of times the user has successfully mimicked the current media content, or the number of successful mimicry attempts overall. In some examples, the system may provide an indication of the similarity score (e.g., a numerical value, a color, shading, or other visual or audible indicator of how well the user mimicked the media content). Additionally, in some embodiments the system may provide an indication of an unsuccessful mimicry attempt, and/or provide information indicating how the user can improve their mimicry (e.g., speed up, slow down, change pitch or cadence, enunciate, etc.).

FIG. 4 illustrates various metrics and techniques that can be used to determine the similarity score between the media content and the user's attempted mimicry. Determination of the similarity score may be understood as occurring in two stages-first alignment of the media content to the user input, and second a comparison between the aligned signals.

In order to align and compare the media content with the user input, the system may consider both the audio features and the content features of the two signals. The audio features may comprise the timing and/or spectral information, and the content features may comprise the words, syllables, etc. User input may vary across a wide spectrum, with one extreme being that the user treats the mimicry like Karaoke by being loud and attempting to exactly copy the media content. On the other hand, the other extreme may be where a user simply hums along to the media content, without speaking any words or phrases. Embodiments disclosed herein attempt to address both extremes, as well as any user that falls in between, by balancing the alignment and comparison operations and performing a weighted alignment operation based on both the audio features and the content features of the signals being compared.

To perform the alignment, the system may consider both the audio features and the content features of the two signals. The audio features may include information such as mel-frequency cepstrum coefficients (MFCC), spectrograms, or spectral characteristics of the input audio from the user and the media content audio. These audio features may be identified based on an analysis of the input audio and/or the media content audio, performed by the output device or some other computing device (e.g., server). These audio features may be denoted for sequences A and B (e.g., the media content audio (A) and the user input audio (B) respectively) as A_{audio}[i] and B_{audio}[j].

The content features may include information such as word embeddings, phonemes, or textual representations of the input audio from the user and the media content audio. For the media content audio, these features may be determined from various sources, such as based on an analysis of the audio by the output device or another computing device, from a manifest corresponding to the media content, from the closed captions or subtitles of the media content, or via any other suitable information source. These content features may be denoted for sequences A and B as A_{content}[i] and B_{content}[j].

In some examples, the system may perform a weighted alignment between the media content audio and the input audio from the user using both the audio-based and content-based features with Dynamic Time Warping (DTW). This enables the system to use a hybrid cost function that combines the contributions of both feature types, providing the optimal alignment.

The weighted cost function may be a combined cost function that incorporates both audio and content features with associated weights. An example formula for the combined cost function may be:

$$Cost ( i , j ) = α \cdot distance ( {A}_{audio} [ i ] , {B}_{audio} [ j ] ) + β \cdot distance ( {A}_{content} [ i ] , {B}_{content} [ i ] )$$

where:
distance (A_{audio}[i], B_{audio}[j]) corresponds to a distance metric between the audio features of A and B (e.g., Euclidean distance, cosine similarity, etc.),
distance (A_{content}[i], B_{content}[j]) corresponds to a distance metric between the content features of A and B, and
α and β are the weights that control the influence of the audio-based and content-based features in the alignment process, respectively. These weights should sum to 1 (i.e., α+β=1) to normalize the combined cost.

The weighted DTW algorithm is a recursive function that may be configured to calculate the cumulative cost by considering both the audio feature and content feature alignment. The recursive formula may be:

$$DTW ( i , j ) = Cost ( i , j ) + min \{ \begin{matrix}DTW ( i - 1 , j ) & insertion \\ DTW ( i , j - 1 ) & deletion \\ DTW ( i - 1 , j - 1 ) & match\end{matrix}$$

where:
Cost (i, j) is the combined cost noted above, and
DTW (i, j) represents the cumulative cost of aligning the sequences up to indices i and j.

In order to determine the proper alignment, the system may use boundary conditions to restrict the search space so that the alignment process can be performed quickly and accurately. To initialize the boundary conditions for the DTW matrix, the system may begin with:

$$DTW ( 0 , 0 ) = 0$$

$$DTW ( i , 0 ) = ∞ for i > 0$$

$$DTW ( 0 , j ) = ∞ for j > 0$$

The choice of values for α and β may depend on the relative importance of the audio features and content features in a particular implementation. For instance, if the textual information or content feature are more critical for alignment, the system may set α=0.3 and β=0.7. This may occur, for example, when the mimicked phrase is simply spoken text, or when the determination is less reliant on matching the pitch, cadence, or other spectral features, and is instead reliant on matching the correct words. For instance, where the audio features and content features have relatively equal importance, α and β may each be set to 0.5. And if the audio features have more importance than the content features, the system may set α=0.7 and β=0.3, for example. This may be useful where the mimicry from the user is simply humming along, and there is no text to directly compare (e.g., the user hums along to “I'm Lovin' It” during a McDonald's advertisement).

In some examples, the system may adjust these weights empirically and/or dynamically based on the alignment performance, and/or over time as more and more mimicry attempts are made and analyzed. For example, as the system receives more and more mimicry attempts, the alignment process may be refined to make it easier and/or harder for the mimicry to be detected. That is, the weights may be adjusted over time as the system receives inputs, so as to fine tune the process and make more accurate determinations of whether a user is mimicking the presented media content or not. Alternatively, the system may adjust the similarity score threshold over time (e.g., based on the inputs received) to achieve a similar outcome of making more accurate mimicry determinations. Two example strategies to dynamically determine the weights (α and β) used in the alignment process are data-driven weight adjustment based on either variance or Signal-to-Noise ratio.

Variance-based weighting for α and β may correspond to weighting values that indicate how important each of the audio feature distance and the content feature distances are. For example, a monotone input may correspond to less importance tied to the audio features of the analysis than the content features. The system may calculate the variance of the audio feature and/or content feature distances (or other metrics) across the entire dataset. A higher variance may indicate that a feature type is more informative, so the system may assign a higher weight to the feature with higher variance. An example formula for variance based weighting may be:

$$α = \frac{Var ( content distances )}{Var ( audio distances ) + Var ( content distances )}$$

$$β = \frac{Var ( audio distances )}{Var ( audio distances ) + Var ( content distances )}$$

Signal-to-noise ratio (SNR) based weighting may also provide insight into which of the audio features or the content features are more important, or carry relatively more information. In a scenario with the user input content does not match the media content but the audio features do (e.g., the user sings along with the correct pitch and cadence, but with the wrong words), the features that have a higher SNR may be weighted higher to enable more optimal alignment. The system may determine the SNR for the audio and content features of both the media content and the user input, in order to determine what the weights for the alignment algorithm should be. In one example, the formula for SNR based weighting may be:

$$α = \frac{S N {R}_{content}}{S N {R}_{audio} + S N {R}_{content}}$$

$$β = \frac{S N {R}_{audio}}{S N {R}_{audio} + S N {R}_{content}}$$

In some embodiments, the weighting values for a and B may be based on the variance and/or SNR for the media content more than based on the variance and/or SNR for the user input. If the user puts in more effort to the user input, then the weights may be updated to be based more on the user input than on the media content.

Once the DTW matrix is fully populated, the system may backtrack from DTW (m,n) (where m and n are the lengths of the sequences) to extract the optimal alignment path. This alignment path may provide the temporal alignment between the media content and the user input considering both the audio features and content features of both signals. The weighted DTW approach noted herein may enable alignment of speech recordings based on both their audio characteristics and the content of what is spoken, providing a more robust alignment that accounts for both aspects. This is the major difference from Karaoke, in which synchronization is the key component.

It should be appreciated that the alignment process described herein may be performed locally (e.g., on the output device, the remote control, the phone, etc.), or may be performed at a server or other device connected via a network. In some embodiments, the output device (or other processing device) may receive a manifest, text, or other data associated with media content that can be used in the alignment process.

In some examples, the system may retrieve the audio features and/or content features for the media content. These features may be pre-determined, and/or provided as information in the manifest, metadata, or other information along with the media content itself. Performing the comparison between the media content and the input audio from the user may then be performed with relatively less computational requirements, and/or can be performed locally. The system also enables other actions to be taken, such as pre-caching media content (e.g., advertisements) locally, and changing the media content that is scheduled to be presented to the user. In some embodiments, the system may pre-cache or buffer a portion of the media content and may match the input audio within the lead time (discussed below), which may help to inform what media content to request and play next. This enables the system to operate using less network and computational resources than would otherwise be required. In some embodiments, caching media content to be presented to the user can be beneficial, because once the mimicry has been determined, the system may want to quickly switch the presented content (e.g., skip the current ad). For some approaches, such as a choose your own adventure type of media content, it is currently difficult and computationally expensive to maintain big enough branches to be meaningful because of bandwidth limits.

Once the alignment between the media content and the user input is determined, the next step in determining the similarity score is to perform a comparison between the aligned signals. It may be desirable to measure the speech similarities, not just in textual content, but also in the specific style and timing of the speech. As such, the comparison may occur not just in the text recognized by automatic speech recognition (ASR), but also in phoneme, pitch and timing (pace), among other things. Therefore, it may be beneficial to not simply use a frequency-domain analysis to compare the overall spectral properties of the two speech recordings, because two speech recordings may have the same spectral property, but entirely different content.

FIG. 4 illustrates four plots showing example comparisons between media content audio and input audio from a user, for comparisons between phonemes (400), pitch (420), timing precision (440), and showing a tracked similarity score for a user over time (460).

In plot 400, phoneme matching compares the match scores of phonemes between the media content audio 402 and the user input audio 404. The closer the scores of signals 402 and 404 are to each other, the more accurately the mimicry matches the media content phrase. It should be appreciated that phoneme matching provides an analysis on a phoneme by phoneme basis, and that other suitable comparisons may be made as well or instead, such as syllable, word, phrase, or other segment analysis.

In plot 420, pitch matching is performed over time for both the media content audio 422 and the user input audio 424. Similar wave patterns for the signals 422 and 424 indicate that the pitch is closely mimicked.

In plot 440, timing precision is illustrated between the media content audio 442 and the user input audio 444. This plot shows the timing of syllables in each of the respective signals, which may correspond to the pace or cadence at which the media content and/or user speech proceeds. Note that the timing measurement is relative between pairs of syllables, and may not be based on a synchronization between the user's input speech and the original media content audio. For example, the viewer may speak earlier or later than the media content audio (measured by “lead time,” discussed below), but there may still be a good match (e.g., high similarity score). The closer the timing is for the pairs of syllables, the more precise the mimicry is in terms of timing.

After performing the alignment between the media content and the user input, the system may know whether the user input was provided earlier or later than the original audio from the media content. This can be measured based on the starting time of each of the media content audio and/or the user input audio, syllable-wise, term wise, phoneme wise, or any other suitable segment-wise analysis of the two signals. If the user input is consistently ahead of the media content, that information may indicate that the user is more familiar with the media content (since he or she is saying the phrase(s) before the output device presents them). Alternatively, if the user input is consistently after the media content, that may indicate less familiarity from the user. Additionally, if a user input is late by a short duration (e.g., 100 ms), that may indicate the user is familiar with and is mimicking the media content, whereas if a user input is late by a longer duration (e.g., 4 seconds), that may indicate the user is not familiar with the media content and is instead repeating what they hear back on a delay. In some examples, the system may include a lead time threshold such that lead time less than the threshold may indicate familiarity with the media content, while lead time greater than the threshold indicates the user is not familiar with the media content. In some embodiments, the system may use a binary value to evaluate for each segment, phoneme or word, whether the user input is leading the corresponding media content plus a delta time dₜ, and using an overall percentage to measure the lead time, i.e., for each phoneme Pᵢ, if the mimicked user input time tm(pᵢ) is earlier than media content time plus a small delay dₜ, i.e., tm(pᵢ)<tₒ(pᵢ)+dₜ, we denote Lᵢ=1, otherwise Lᵢ=0. In one embodiment, the delta time may be on the order of 100 milliseconds. The overall lead time may be calculated as:

$$Lead Time = \frac{{\sum }_{i = 1}^{n} {L}_{i}}{n} \cdot 100 \%$$

In some embodiments, lead time may be correlated with how much of the media content the user has memorized and how much is repeated after the media content is presented (e.g., how familiar the user is). The lead time may inform or may be correlated with how much of the user input comes from the user's memory and how much comes from repeating the media content after it has been presented. If the system determines that user input is preempting the advertisement (e.g., the user is speaking each phrase before the advertisement plays) then it may indicate that the user is very familiar with the advertisement and can be used to inform the rewards that are provided.

Plot 460 illustrates the change in similarity score 466 for a given user over time as a given advertisement is repeatedly presented to the user. As can be seen, as the number of iterations or attempts of the user mimicking a phrase from media content increases, the similarity score also increases as the user's familiarity and skill at mimicry increases. The change in similarity score over time may be a metric that is used to inform which actions are taken by the system.

Once the similarity score has been determined, the system may compare it to a similarity threshold. If the similarity score is below the threshold, that may indicate that there was not a match, and/or the user was not actually attempting to mimic the presented media content. However, if the similarity score is at or above the threshold, that may indicate a successful attempt to mimic the media content.

Based on the similarity score being at or above the threshold, the system may take one or more actions. In some examples, the output device may provide a visual or audio indication (e.g., thumbs up and/or chime) as described above with respect to FIG. 3. In other examples, the system may skip to the end of the media content, particularly where the media content comprises an advertisement. In some examples, the system may skip presentation of a subsequent advertisement, or a subsequent portion of media content that is scheduled for display. In still other examples, the system may provide a reward, such as unlocking special offers or exclusive content, providing loyalty points, a discount towards a product or service being advertised, and more.

In some examples, when the user performs well but with minor deviations in mimicry, the system may provide smaller rewards, such as shortening the next ad, offering a minor incentive compared to the high mimicry score rewards. Additionally or alternatively, the system may alter playback of the media content (e.g., rewind, replay, not replay, etc.), or may modify the media content playback in some way (e.g., add new content, replace some content, remove some content, etc.). In some examples, the level of reward provided may depend on the similarity score, and/or on a difference between the similarity score and the similarity score threshold.

In some examples, if the user attempts mimicry but with significant deviations, i.e., a very low similarity score, the system may offer encouragement by providing visual and/or audio prompts, and suggesting tips on how to improve the mimicry.

In some examples, when the system detects no mimicry, i.e., the user does not engage in mimicry, the media content may continue without any interaction or reward, and the system may prompt the viewer for mimicry in future advertisements.

In some examples, there may be multiple similarity thresholds, such as low, medium, and high. The system may take a different action depending on whether the similarity score is above a high threshold, between a high and medium threshold, between a medium and low threshold, or below a low threshold, for example. Other numbers and combinations of thresholds and corresponding actions may be used as well.

In some examples, the system may keep a scoring system and track mimicry performance over time. A higher score may unlock better rewards and/or more favorable content alteration (e.g., adding, removing, or replacing content), thereby encouraging repeated engagement with advertisements. In some examples, the system may record the user input, and if the user mimicry exceeds a certain threshold, the upcoming scheduled advertisement may be presented with the user's audio instead of the media content audio itself. That is, the user's singing of a catchphrase may be inserted into an advertisement the next time it is presented. For example, for a system comprising an output device and an input device (e.g., microphone), the system may detect a very high similarity score and may then transfer the recording of the mimicry from the input device to the cloud (or another computing device configured to provide the media content), and then to the output device. Then, the next time the output device displays the same media content that was previously mimicked, a portion of that media content may be altered to include the recording of the mimicry.

In some examples, a successful mimicry by a user, and/or the similarity score, may be provided to an advertising platform to be used in making decisions on which advertisements to provide to users. The advertising platform may select advertisements based on an ad-targeting algorithm, which may be updated or modified based on determining that the similarity score for a given user and displayed advertisement is above the similarity threshold. For example, if a user routinely mimics a certain type of advertisement (e.g., sports), the advertising platform may use this information to inform the future advertisements that are presented to the user.

In some examples, the user's mimicry may not occur during the presentation of the advertisement itself (or may be delayed during presentation of the advertisement). Some advertisements may be designed to allow the user time to react and start mimicking. Some advertisements may be designed to allow for an evolution of the mimicking requirements (e.g., a first version of the advertisement may start with just a jingle; once the user successfully mimics the jingle, a second version of the advertisement may be presented including a different portion that is designed to be mimicked, such as a catch phrase or gesture, to trigger a more elaborate response from the user, and which also varies and enhances engagement with the content.

In some examples, in response to determining that a similarity score is above the similarity threshold for a given media content when presented a first time, the system may take a first action. Then, when the advertisement is presented a second or subsequent time, successfully mimicry may cause the system to take a second action, different from the first action. For example, the first time a user mimics an advertisement, the system may provide a reward of points to the user. Then, when the user mimics the advertisement a second time it is presented, the system may skip to the end of the advertisement rather than or in addition to providing the point reward.

In some examples, the system may skip to a particular portion of the media content in response to the user mimicry. For instance, where the user mimics the speech of a first character (e.g., a princess), the media content may skip forward to a portion that corresponds to the first character. Alternatively, if the user mimics the speech of a second character (e.g., a jester), the media content may skip to a different portion of the media content that corresponds to the second character.

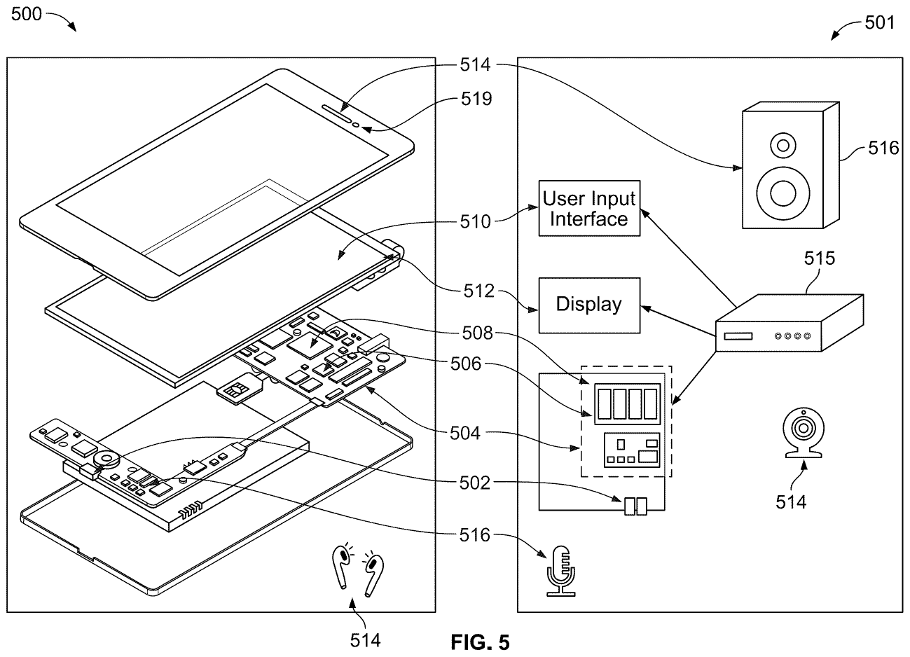

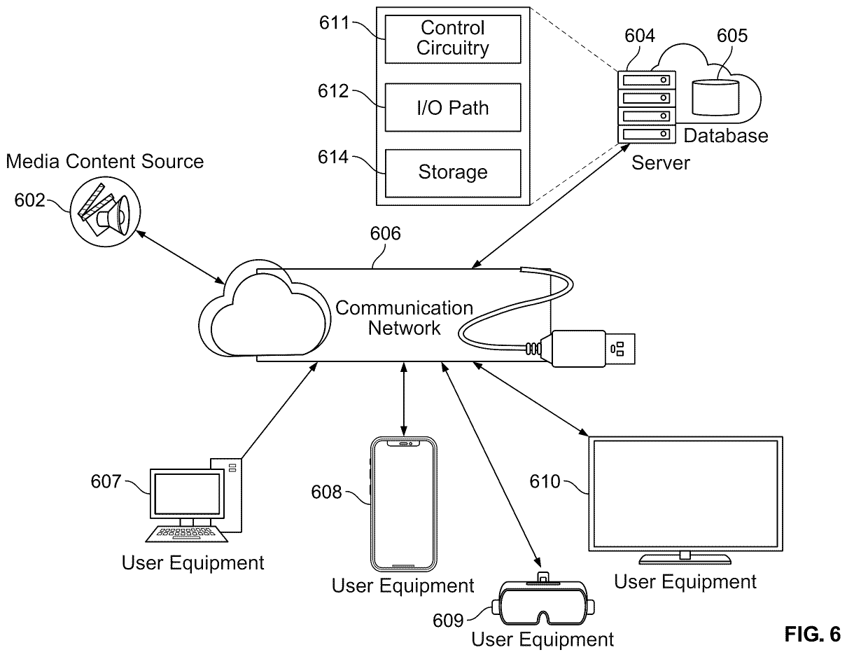

FIGS. 5-6 describe illustrative devices, systems, servers, and related hardware for a system for performing the functions described herein. FIG. 5 shows generalized embodiments of illustrative user devices 500 and 501. For example, user equipment device 500 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 501 may be a user television equipment system or device. User television equipment device 501 may include set-top box 515. Set-top box 515 may be communicatively connected to microphone 516, audio output equipment (e.g., speaker or headphones 514), and display 512. In some embodiments, microphone 516 may receive audio corresponding to a voice of a user, e.g., a voice command. In some embodiments, display 512 may be a television display or a computer display. In some embodiments, set-top box 515 may be communicatively connected to user input interface 510. In some embodiments, user input interface 510 may be a remote control device. Set-top box 515 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 6. In some embodiments, device 500 may comprise any suitable number of sensors, as well as a GPS module (e.g., in communication with one or more servers and/or cell towers and/or satellites) to ascertain a location of device 500.

Each one of user equipment device 500 and user equipment device 501 may receive content and data via input/output (I/O) path 502. I/O path 502 may provide content (e.g., broadcast programming, on-demand programming, Internet content, content available over a local area network (LAN) or wide area network (WAN), and/or other content) and data to control circuitry 504, which may comprise processing circuitry 506 and storage 508. Control circuitry 504 may be used to send and receive commands, requests, and other suitable data using I/O path 502, which may comprise I/O circuitry. I/O path 502 may connect control circuitry 504 (and specifically processing circuitry 506) to one or more communications paths (described below). I/O functions may be provided by one or more of these communications paths, but are shown as a single path in FIG. 6 to avoid overcomplicating the drawing. While set-top box 515 is shown in FIG. 6 for illustration, any suitable computing device having processing circuitry, control circuitry, and storage may be used in accordance with the present disclosure. For example, set-top box 515 may be replaced by, or complemented by, a personal computer (e.g., a notebook, a laptop, a desktop), a smartphone (e.g., device 500), a tablet, a network-based server hosting a user-accessible user device, a non-user-owned device, any other suitable device, or any combination thereof.

Control circuitry 504 may be based on any suitable control circuitry such as processing circuitry 506. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for the system stored in memory (e.g., storage 508). Specifically, control circuitry 504 may be instructed to perform the functions discussed above and below. In some implementations, processing or actions performed by control circuitry 504 may be based on instructions received from an application configured to perform the features described herein.

In client/server-based embodiments, control circuitry 504 may include communications circuitry suitable for communicating with a server or other networks or servers. The media application described herein may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 508 and executed by control circuitry 504 of a device 500.

In some embodiments, the media application may be a client/server application where only the client application resides on device 500, and a server application resides on an external server (e.g., server 604). For example, the media application may be implemented partially as a client application on control circuitry 504 of device 500 and partially on server 604 as a server application running on control circuitry 611. Server 604 may be a part of a local area network with one or more of devices 500 or may be part of a cloud computing environment accessed via the internet. In a cloud computing environment, various types of computing services for performing searches on the internet or informational databases, providing storage (e.g., for a database 605) or parsing data are provided by a collection of network-accessible computing and storage resources (e.g., server 604), referred to as “the cloud.” Device 500 may be a cloud client that relies on the cloud computing capabilities from server 604 to determine whether processing should be offloaded and facilitate such offloading. When executed by control circuitry 504 or 611, the media application may instruct control circuitry 504 or 611 to perform processing tasks for the user device and facilitate a media consumption session integrated with social network services. The client application may instruct control circuitry 504 to determine whether processing should be offloaded.

Control circuitry 504 may include communications circuitry suitable for communicating with a server, social network service, a table or database server, or other networks or servers. The instructions for carrying out the above-mentioned functionality may be stored on a server (which is described in more detail in connection with FIG. 6). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 508 may be used to store various types of content described herein as well as media application data described above. Nonvolatile memory may also be used (e.g., to launch a boot-up routine and other instructions). Cloud-based storage may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 504 may also include scaler circuitry for upconverting and down converting content into the preferred output format of user equipment 500. Control circuitry 504 may also include digital-to-analog converter circuitry and analog-to-digital converter circuitry for converting between digital and analog signals. The tuning and encoding circuitry may be used by user equipment device 500, 501 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 508 is provided as a separate device from user equipment device 500, the tuning and encoding circuitry (including multiple tuners) may be associated with storage 508.

Control circuitry 504 may receive instruction from a user by way of user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of user equipment device 500 and user equipment device 501. For example, display 512 may be a touchscreen or touch-sensitive display. In such circumstances, user input interface 510 may be integrated with or combined with display 512. In some embodiments, user input interface 510 includes a remote-control device having one or more microphones, buttons, keypads, any other components configured to receive user input or combinations thereof. For example, user input interface 510 may include a handheld remote-control device having an alphanumeric keypad and option buttons. In a further example, user input interface 510 may include a handheld remote-control device having a microphone and control circuitry configured to receive and identify voice commands and transmit information to set-top box 515.

Audio output equipment 514 may be integrated with or combined with display 512. Display 512 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 512. Audio output equipment 514 may be provided as integrated with other elements of each one of device 500 and equipment 501 or may be stand-alone units. An audio component of videos and other content displayed on display 512 may be played through speakers (or headphones) of audio output equipment 514. In some embodiments, audio may be distributed to a receiver (not shown), which processes and outputs the audio via speakers of audio output equipment 514. In some embodiments, for example, control circuitry 504 is configured to provide audio cues to a user, or other audio feedback to a user, using speakers of audio output equipment 514. There may be a separate microphone 516 or audio output equipment 514 may include a microphone configured to receive audio input such as voice commands or speech. For example, a user may speak letters or words that are received by the microphone and converted to text by control circuitry 504. In a further example, a user may voice commands that are received by a microphone and recognized by control circuitry 504. Camera 518 may be any suitable video camera integrated with the equipment or externally connected. Camera 518 may be a digital camera comprising a charge-coupled device (CCD) and/or a complementary metal-oxide semiconductor (CMOS) image sensor. Camera 518 may be an analog camera that converts to digital images via a video card.

The media application may be implemented using any suitable architecture. For example, it may be a stand-alone application wholly-implemented on each one of user equipment device 500 and user equipment device 501. In such an approach, instructions of the application may be stored locally (e.g., in storage 508), and data for use by the application is downloaded on a periodic basis (e.g., from an out-of-band feed, from an Internet resource, or using another suitable approach). Control circuitry 504 may retrieve instructions of the application from storage 508 and process the instructions to provide media consumption and social network interaction functionality and generate any of the displays discussed herein. Based on the processed instructions, control circuitry 504 may determine what action to perform when input is received from user input interface 510. For example, movement of a cursor on a display up/down may be indicated by the processed instructions when user input interface 510 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 504 may allow a user to provide user profile information or may automatically compile user profile information. For example, control circuitry 504 may access and monitor network data, video data, audio data, processing data, participation data from a media application and social network profile. Control circuitry 504 may obtain all or part of other user profiles that are related to a particular user (e.g., via social media networks), and/or obtain information about the user from other sources that control circuitry 504 may access. As a result, a user can be provided with a unified experience across the user's different devices.

In some embodiments, the media application is a client/server-based application. Data for use by a thick or thin client implemented on each one of user equipment device 500 and user equipment device 501 may be retrieved on-demand by issuing requests to a server remote to each one of user equipment device 500 and user equipment device 501. For example, the remote server may store the instructions for the application in a storage device. The remote server may process the stored instructions using circuitry (e.g., control circuitry 504) and generate the displays discussed above and below. The user device may receive the displays generated by the remote server and may display the content of the displays locally on device 500. This way, the processing of the instructions is performed remotely by the server while the resulting displays (e.g., that may include text, a keyboard, or other visuals) are provided locally on device 500. Device 500 may receive inputs from the user via input interface 510 and transmit those inputs to the remote server for processing and generating the corresponding displays. For example, device 500 may transmit a communication to the remote server indicating that an up/down button was selected via input interface 510. The remote server may process instructions in accordance with that input and generate a display of the application corresponding to the input (e.g., a display that moves a cursor up/down). The generated display may then be transmitted to device 500 for presentation to the user.

In some embodiments, the media application may be downloaded and interpreted or otherwise run by an interpreter or virtual machine (run by control circuitry 504). In some embodiments, the media application may be encoded in the ETV Binary Interchange Format (EBIF), received by control circuitry 504 as part of a suitable feed, and interpreted by a user agent running on control circuitry 504. For example, the media application may be an EBIF application. In some embodiments, the media application may be defined by a series of JAVA-based files that are received and run by a local virtual machine or other suitable middleware executed by control circuitry 504. In some of such embodiments (e.g., those employing MPEG-2 or other digital media encoding schemes), the media application may be, for example, encoded and transmitted in an MPEG-2 object carousel with the MPEG audio and video packets of a program.

FIG. 6 is a diagram of an illustrative system 600, in accordance with some embodiments of this disclosure. User equipment devices 607, 608, 609, 610 may be coupled to communication network 606. Communication network 606 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 606) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the user devices may be provided by one or more of these communications paths but are shown as a single path in FIG. 6 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 1002-11x, etc.), or other short-range communication via wired or wireless paths. The user equipment devices may also communicate with each other directly through an indirect path via communication network 606.

System 600 may comprise media content source 602, one or more servers 604, and one or more social network services. In some embodiments, the media application may be executed at one or more of control circuitry 611 of server 604 (and/or control circuitry of user equipment devices 607, 608, 609, 610.

In some embodiments, server 604 may include control circuitry 611 and storage 614 (e.g., RAM, ROM, Hard Disk, Removable Disk, etc.). Instructions for the media application may be stored in storage 614. In some embodiments, the media application, via control circuitry, may execute functions outlined in FIGS. 1-4 and 7. Storage 614 may store one or more databases. Server 604 may also include an input/output path 612. I/O path 612 may provide media consumption data, social media data, device information, or other data, over a local area network (LAN) or wide area network (WAN), and/or other content and data to control circuitry 611, which may include processing circuitry, and storage 614. Control circuitry 611 may be used to send and receive commands, requests, and other suitable data using I/O path 612, which may comprise I/O circuitry. I/O path 612 may connect control circuitry 611 (and specifically control circuitry) to one or more communications paths. I/O path 612 may comprise I/O circuitry.

Control circuitry 611 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 611 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 611 executes instructions for an emulation system application stored in memory (e.g., the storage 614). Memory may be an electronic storage device provided as storage 614 that is part of control circuitry 611.

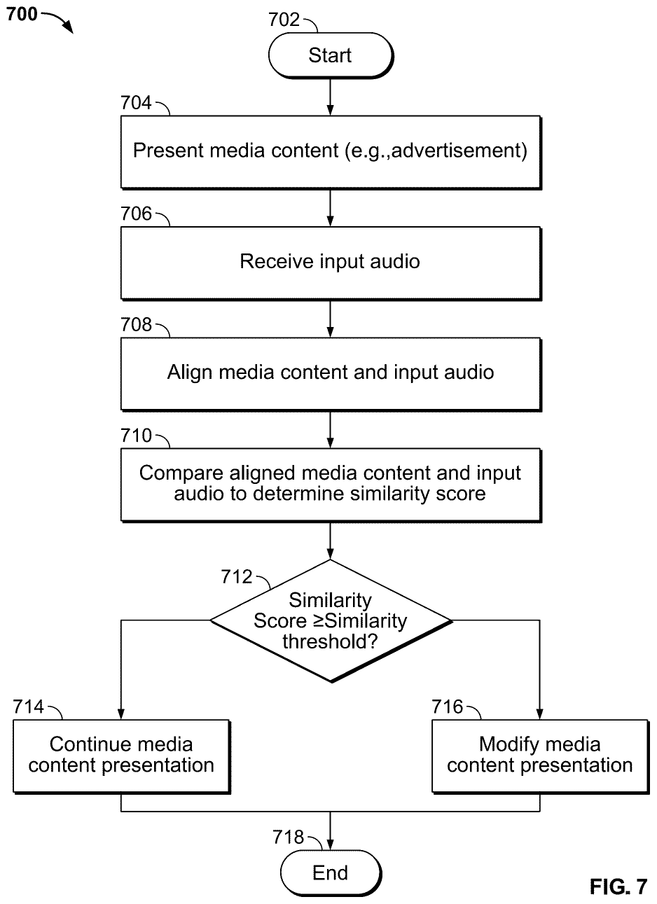

FIG. 7 is a flowchart of an example process for presenting media content and detecting user mimicry of the media content, in accordance with some embodiments of this disclosure. In various embodiments, the individual steps of process 700 may be implemented by one or more components of the devices and systems of FIGS. 1-6, e.g., output device 110 of FIG. 1. Although the present disclosure may describe certain steps of process 700 (and of other processes described herein) as being implemented by certain components of the devices and systems of FIGS. 1-6, this is for purposes of illustration only, and it should be understood that other components of the devices and systems of FIGS. 1-6 may implement those steps instead.

Process 700 begins at step 702. At step 704, the process includes presenting media content via an output device. The output device may be a television, computer, tablet, or other suitable output device configured to present media content to a user. The media content may be an advertisement in some examples and may include advertisement audio that is intended to be mimicked by a user. Step 704 may also include presenting a visual indication that user mimicry is expected, such as is shown in further detail with respect to FIG. 2.

At step 706, the process includes receiving input audio. The input audio may be from a user viewing or listening to the media content, and attempting to mimic some portion of the media content. In some examples, the output device may include a sensor such as a microphone, configured to activate when the portion of the media content that is intended to be mimicked is presented. Alternatively, the input audio may be received by a remote control with a microphone, or a phone, either of which may be communicatively coupled to the output device.

At step 708, the process 700 includes aligning the media content with the input audio. The process of alignment is described in further detail above with respect to FIG. 4. At step 710, the process includes comparing the aligned media content and input audio to determine a similarity score. This process is described in further detail above with respect to FIG. 4. As a result of steps 708 and 710, the system determines a similarity score indicating how well the user has mimicked a portion of the media content that is being presented.

At step 712, the process includes determining whether the similarity score is at or above a similarity threshold. If the similarity score is below the threshold, the process proceeds to step 714 at which the media content continues to be presented as a normal advertisement would, i.e. without interruption or a delay while waiting for affirmative user input. If the similarity score is determined to be at or above the threshold, the process proceeds to step 716.

At step 716, the system modifies the presentation of the media content. Modifying the presentation of the media content may include skipping to an end of the media content (e.g., ending the advertisement early), skipping to a later portion of the media content, modifying portion of the media content or some other media content, or otherwise changing or modifying some portion of the presentation. In some examples, the system may provide a series of advertisements or other media content that is scheduled to be displayed in order (e.g., five advertisements displayed in a row). In this case, based on detecting mimicry of a first advertisement, the system may replace the scheduled fifth advertisement with a substitute advertisement. The substitute advertisement may be a new advertisement, may be a repetition of the first advertisement, or may be a new version or altered version of one or more of the scheduled advertisements. In some examples, modifying the presentation of the media content may include providing a visual or audible indication that the user has successfully mimicked the media content. This is discussed in further detail above with respect to FIG. 3. The process 700 may then end at step 718.

The embodiments above are described primarily with reference to media content audio and corresponding user input audio, and the comparison between the two. However, it should be appreciated that other embodiments may include performing the same type of analysis and features as described above but with respect to gesture recognition. For example, some computing devices may include gesture recognition capabilities (e.g., including cameras or inertial sensors), which may enable a user to mimic actions or gestures that are presented in an advertisement or other media content. For example, the mimicked gestures may be as simple as raising a hand or mimicking a dance move. The system described herein may detect the user's gesture and confirm familiarity with the presented advertisement. The similarity score analysis may include comparing a gesture present in the media content to a captured gesture from the user, such as via image and/or video analysis.

In some examples, the presented media content may include one or more interactive elements that encourage the user to mimic specific actions that are then recognized by the system. For example, an advertisement might present the text, “Wave to skip,” and if the viewer mimics this action, the system may end the advertisement presentation early or provide an appropriate reward.

In some examples, the system may perform facial recognition or detect emotional responses. For instance, if a presented advertisement is humorous or has a memorable moment, the system may use facial recognition (via a sensor such as a camera) to detect if the viewer smiles or laughs at the correct moment, thereby confirming familiarity with the content (and thus enabling the one or more responsive actions described herein to be performed). Additionally, in some examples, the system may detect whether input audio originates from the user or from some other source, so as to determine whether a user is attempting to fake mimicry such as by recording and replaying the original audio from the media content. The system may also distinguish which user of multiple users provides the mimicry input. This information may then be used to distinguish the user providing the mimicry for future playback of media content.

In some examples, once familiarity is confirmed through emotional recognition, the advertisement may be adapted with a personalized message, such as “We see you enjoyed this last time—here's something special for you!”

In some examples, the system may perform a gamification of the advertising experience. For example, viewers may earn points or levels based on how accurately they mimic particular advertisements. The system may include a leaderboard for social and/or competitive engagement for each mimic-able advertisement, and/or may adjust the difficulty level of mimicking adaptively.

In some examples, the system may continuously or at regular intervals monitor user mimicking cues or inputs and may attempt to correlate the mimicking signals with content after content is aired. Because mimicking can take place in any other situation than right when the content is aired, this may enable a determination of whether the user is familiar with a particular advertisement based on the user's mimicry that occurs uncorrelated in time with the advertisement itself. For example, in some examples advertisements may be designed to allow a user to mimic while the advertisement is playing by, for instance, allowing sufficient time for a user to react and start mimicking. In other examples, an advertising campaign may be designed to allow for an evolution of the mimicking requirements. For instance, an ad campaign may start with just a jingle in one creative. Upon detection that the jingle has been repeated/mimicked by a viewer/household, an advertising network may decide to play another version of the advertisement to attempt at triggering a more elaborate response from the viewer. This will support an effort from a brand to move from a top-of-the-funnel brand awareness message to a more targeted product related message and receive the appropriate signals as to when that switch would be the most effective.

In some examples, the system may share information with an advertising network, and/or may use the information regarding detected mimicry to modify ad impression counts and/or the bidding process for advertisers. In an example, after detecting that an advertisement has been mimicked to a certain level (e.g., determining that the similarity score is above a threshold), the system may inform an ad network of that determination. The ad network may then alter the bidding process to include information that an ad may be presented to a mimicking audience. For instance, advertisers may be more interested in presenting a given advertisement to users that have previously mimicked the advertisement, or alternatively to users that have not previously mimicked the advertisement. In addition to determining whether mimicry has occurred, the system may further determine demographic information about the mimicking audience and may transfer that information to the ad network for use in bidding.

The processes discussed above are intended to be illustrative and not limiting. One skilled in the art would appreciate that the steps of the processes discussed herein may be omitted, modified, combined and/or rearranged, and any additional steps may be performed without departing from the scope of the disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
presenting, by an output device, media content comprising media content audio;
receiving, during presentation of the media content by the output device, input audio;
aligning the input audio with the media content audio;
determining a similarity score based on the aligned input audio and media content audio; and
based on determining that the similarity score is above a similarity threshold, modifying presentation of the media content.

2. The method of claim 1, wherein aligning the input audio with the media content audio comprises performing a weighted alignment between the input audio and the media content audio based on respective audio features of the input audio and the media content audio, and respective content features of the input audio and the media content audio.

3. The method of claim 2, wherein performing the weighted alignment between the input audio and the media content audio comprises using dynamic time warping (DTW) and a hybrid cost function that combines contributions from the audio features and the content features of the input audio and the media content audio.

4. The method of claim 2, wherein the audio features comprise one or more of mel-frequency cepstrum coefficients (MFCC), spectrograms, or spectral characteristics of the input audio and the media content audio.

5. The method of claim 2, wherein the content features comprise one or more of word embeddings, phonemes, or textual representations of the input audio and the media content audio.

6. The method of claim 1, wherein determining the similarity score comprises analyzing the input audio and the media content audio based on one or more of phoneme matching, pitch matching, timing precision, or lead time.

7. The method of claim 1, further comprising providing a visual indication overlaid on the presentation of the media content that the similarity score is above the similarity threshold.

8. The method of claim 1, wherein modifying the presentation of the media content comprises skipping presentation of a portion of the media content.

9. The method of claim 1, wherein the media content comprises an advertisement, the method further comprising:
selecting the advertisement based on an ad-targeting algorithm; and
based on determining that the similarity score is above the similarity threshold, modifying the ad-targeting algorithm.

10. The method of claim 1, further comprising, based on determining that the similarity score is above the similarity threshold, providing a reward, wherein the reward is selected based on the similarity score.

11. The method of claim 1, further comprising providing, by the output device during presentation of the media content, a prompt instructing a user to provide the input audio.

12. A system comprising:
input/output circuitry configured to:
present, at an output device, media content comprising media content audio; and
receive, during presentation of the media content by the output device, input audio; and
control circuitry configured to:
align the input audio with the media content audio;
determine a similarity score based on the aligned input audio and media content audio; and
based on determining that the similarity score is above a similarity threshold, modify presentation of the media content.

13. The system of claim 12, wherein the control circuitry is further configured to align the input audio with the media content audio by performing a weighted alignment between the input audio and the media content audio based on respective audio features of the input audio and the media content audio, and respective content features of the input audio and the media content audio.

14. The system of claim 13, wherein the control circuitry is further configured to perform the weighted alignment between the input audio and the media content audio by using dynamic time warping (DTW) and a hybrid cost function that combines contributions from the audio features and the content features of the input audio and the media content audio.

15. The system of claim 13, wherein the audio features comprise one or more of mel-frequency cepstrum coefficients (MFCC), spectrograms, or spectral characteristics of the input audio and the media content audio.

16. The system of claim 13, wherein the content features comprise one or more of word embeddings, phonemes, or textual representations of the input audio and the media content audio.

17. The system of claim 12, wherein the control circuitry is further configured to determine the similarity score by analyzing the input audio and the media content audio based on one or more of phoneme matching, pitch matching, timing precision, or lead time.

18. The system of claim 12, wherein the input/output circuitry is further configured to provide a visual indication overlaid on the presentation of the media content that the similarity score is above the similarity threshold.

19. The system of claim 12, wherein the control circuitry is further configured to modify the presentation of the media content by skipping presentation of a portion of the media content.

20. The system of claim 12, wherein the media content comprises an advertisement, and wherein the control circuitry is further configured to:
select the advertisement based on an ad-targeting algorithm; and
based on determining that the similarity score is above the similarity threshold, modify the ad-targeting algorithm.

21-55. (canceled)
